(19) United States
(12) Patent Application Publication
(10) Pub. No.: US 2015/0130607 A1
(43) Pub. Date: May 14, 2015

(54) Rear Brake Light System

(71) Applicant: David MacArthur, Concord, NC (US)

(72) Inventor: David MacArthur, Concord, NC (US)

(21) Appl. No.: 14/532,871

(22) Filed: Nov. 4, 2014

Related U.S. Application Data
(60) Provisional application No. 61/902,605, filed on Nov. 11, 2013.

(51) Int. Cl. B60Q 1/44; G01S 15/08; G01S 17/08; G01S 13/08

(52) U.S. Cl. CPC B60Q 1/44; G01S 13/08; G01S 15/08; G01S 17/08
USPC 340/479

(57) ABSTRACT

An improved vehicle brake light system is provided, in which a transmitter and receiver is used to determine the distance and closing velocity of a trailing vehicle relative to a lead vehicle. The distance and closing velocity are used to determine whether a trailing vehicle may cause a risk of collision upon application of the lead vehicle brakes. If the distance between the trailing vehicle and lead vehicle is deemed below a minimum threshold at a given vehicle speed, the rear brake lights are illuminated. If the closing velocity is a trailing vehicle is deemed above a threshold maximum, the system pulses the rear brake lights of the lead vehicle. This improves communication between a lead vehicle and a trailing vehicle, whereby the trailing vehicle is alerted to cease tailgating activity or alternatively to apply the brakes in order to avoid a potential rear-end collision.

### CROSS REFERENCE TO RELATED APPLICATION

This application claims the benefit of U.S. Provisional Application No. 61/902,605 filed on Nov. 11, 2013. The above identified patent application is herein incorporated by reference in its entirety to provide continuity of disclosure.

### BACKGROUND OF THE INVENTION

1. Field of the Invention

The present invention relates to vehicle indicators and systems for alerting following motorists using a vehicle's rear brake lights. More specifically, the present invention relates to a system that monitors the closure rate of a trailing vehicle and the distance between the trailing vehicle and the lead vehicle to apply either a pulsing rear brake signal or a static brake signal, whereby the system includes rear-mounted sensors for tracking the speed and position of the trailing vehicle.

Traffic collisions are a daily reality in today's modern automobile transportation environment. Roads are congested and speeds are quite high on major roads. The close proximity of each vehicle and the volume of vehicles on the road can result in unwanted collisions between motorists, which can range in severity from incidental contact to severe damage to both vehicles. Moreover, severe collisions are a major cause of injury and death in the United States.

Given the number of cars on the road and the energy being transferred between vehicles during a collision, various safety systems have been developed for motorists. While these have greatly reduced the fatality rate on public roads, there is an ever present need to improve safety and thus reduce instances of major injury and property damage. Examples of safety systems include advances in the modern vehicle structures, active restraint systems, and deployable countermeasures (e.g. airbags, etc.), which have all led to a great increase in driver safety. More recent advances have aimed to improve awareness of the driver, and include lane departure warnings, blind spot monitors and the like. However, there remains a need for improved communication between vehicles that can reduce dangerous habits and alert motorists of upcoming emergency stopping events.

It is not uncommon on modern highways for many vehicles to be traveling at a high rate of speed at close proximity to one another. Unforeseen obstacles, sun glare, and broken down vehicles can lead one vehicle to suddenly apply the brakes, forcing vehicles behind a braking vehicle to reduce speed commensurately to avoid a rear end collisions. This is particularly acute during an emergency braking event, in which a lead vehicle is forced to apply extreme braking force to slow the vehicle. If vehicles are traveling behind one another, the following vehicles must react within a short period of time to both acknowledge a rapid change in speed and then to apply the brakes accordingly to avoid colliding with the rear end of the braking vehicle. It is not uncommon to see several vehicles crashed into one another end-to-end on the highway after such an event.

Along with extreme braking events, another common problem on roadways is the behavior of some motorists to “tailgate” another vehicle. Tailgating is the act of one motorist following another at too close of a range. The reduced distance between vehicles creates a dangerous situation at higher speeds, as the trailing vehicle has a reduced time period within which to react to a braking event by the lead vehicle. At higher speeds and at shorter distances, the reaction time is greatly reduced, whereby a trailing vehicle may not be able to physically react and slow the vehicle before colliding into the rear of the lead vehicle. While this activity is illegal in many areas, it persists and often results in rear-end collisions, or at a minimum agitation and ensuing road rage.

To reduce the occurrence of these events and to improve communication between motorists on the roadway, the present invention contemplates a system that can monitor the relative speed and distance of a trailing vehicle from a lead vehicle. The system is in connection with the lead vehicle brake lights and can activate and pulse the brake light output of a vehicle based on the distance and the closing speed of a trailing vehicle. The system includes rearwardly directed transmitter that sends out a signal, which is returned after reflecting from a trailing vehicle. The time required for the return signal is used to calculate distance and closing speed relative to the lead vehicle, which in turn is used to process whether or not to energize or pulse the brake lights of the lead vehicle. If the distance or the closing speed is deemed outside of acceptable limits, the rear brake lights are illuminated or pulsed to alert the following vehicle. This in turn improves the awareness of the trailing vehicle to increase the distance between vehicles, or apply greater brake pressure to avoid a rear-end collision.

2. Description of the Prior Art

Devices have been disclosed in the prior art that relate to brake lights and roadway communication systems on vehicles. These include devices that have been patented and published in patent application publications. The following is a list of devices deemed most relevant to the present disclosure, which are herein described for the purposes of highlighting and differentiating the unique aspects of the present invention, and further highlighting the drawbacks existing in the prior art.

Devices exist in the art related to flashing brake lights as it relates to anti-lock braking systems. These include U.S. Pat. No. 5,801,624 to Tilly, which discloses a brake light indicating device that cooperates with the anti-lock braking system of a vehicle and is activated during an emergency stop. The system flashes the rear brake lights if a predetermined number of brake actuations are registered within a set period of time. Similar to the Tilly device is U.S. Pat. No. 5,017,904 to Browne, which discloses another brake indicator system that pulses the brake lights of a vehicle when the ABS is activated. A wave generator is used to pulse the rear brakes, providing indication to drivers behind the vehicle of ABS activation for cautionary purposes. U.S. Pat. No. 3,629,815 to Hattwig discloses yet another system that flashes the brake lights upon activation of the ABS system.

The Tilly, Browne and Hattwig devices are those that are adapted to activate only when the ABS is active, which occurs during an extreme stopping event or loss of traction while braking. The present invention is not related to the anti-lock braking system, but rather is configured to monitor the trailing distance and closing speed of a vehicle approaching from the rear. Vehicles to the rear of the vehicle are monitored, and a warning signal is generated if a rapidly approaching vehicle closing at too high of a rate or if the vehicle is too close at a given speed. The present invention is related to tailgating and to sudden stops along a roadway. Application of the anti-lock braking system is not required to activate the pulsing brake lights of the present system.

Devices not specifically related to ABS activation include U.S. Pat. No. 7,893,823 to Morales, which discloses a sequential brake light system to warn trailing vehicles based on the deceleration and braking conditions of the vehicle. A brake position sensor and an accelerometer provide inputs to the system, which can track braking force and instantaneous speed of the vehicle. A corresponding deceleration of the vehicle is visualized in a sequential light sequence, which indicates the severity of the braking event such that trailing vehicles can act appropriately to avoid a collision. The Morales device monitors the vehicle within which it is installed and provides a unique brake light array for better visualization by a trailing vehicle.

In contrast to Morales, the present invention monitors the position and speed of a trailing vehicle relative to the vehicle upon which the system is installed. Rather than tracking inputs from the vehicle, external conditions are monitored to provide improved warning to a trailing vehicle if the trailing vehicle's closing speed or position is within a specified range to warrant enhanced rear light warnings after application of the vehicle brakes.

Still yet another device in the prior art is U.S. Pat. No. 6,249,219 to Perez, which discloses a severe braking warning system in which the vehicle's rate of motion is translated into a pulse rate in the rear braking lights of the vehicle to warn motorists behind the vehicle. The Perez system is concerned with severe braking events in which a vehicle must make a sudden stop, and the potential for rear-end collisions that may result. By contrast, the present invention provides a system that monitors the closing speed of a following vehicle relative to the system and initiates a pulsing of the rear lights if the closing speed is judged as too severe when braking.

While the Perez system and the present invention are directed to devices to prevent rear-end collisions under heavy braking, the present invention contemplates monitoring the following vehicle and determining the event from a transmitter/receiver signal. The Perez device monitors the braking system on the vehicle and pulses the brake lights independent of any other motorists. Therefore, the present invention functions only in traffic and when a following vehicle is approaching at a closure rate or distance that is deemed outside of acceptable limits, thereby providing additional warning to the following motorist.

Overall, the present invention describes a new method and system for preventing rear-end collisions and for improving communication between vehicles. The system provides a rearwardly-directed transmitter and receiver that can monitor the distance of an approaching vehicle. The system uses this input to calculate standoff distance and relative speed. The distance and speed are used by the system to determine if the closing rate of speed is too great or if the distance is below a minimum threshold. The system then activates or pulses the rear brakes of the vehicle as a warning signal to the trailing vehicle.

Overall, the present invention provides a system and a method that substantially diverges in elements and steps from the prior art, and consequently it is clear that there is a need in the art for an improvement to existing vehicle brake light warning systems. In this regard the instant invention substantially fulfills these needs.

### SUMMARY OF THE INVENTION

In view of the foregoing disadvantages inherent in the known types of vehicle safety systems now present in the prior art, the present invention provides a new visual communication system that can be utilized for providing convenience for the user when alerting a following vehicle of an emergency braking event.

It is therefore an object of the present invention to provide a new and improved rear brake light system that has all of the advantages of the prior art and none of the disadvantages.

It is another object of the present invention to provide a rear brake light system that utilizes a rearwardly-directed transmitter and receiver to monitor the distance of a trailing vehicle.

Another object of the present invention is to provide a rear brake light system that is capable of activating and pulsing the brake lights of the vehicle if the closure speed of a trailing vehicle is deemed too high.

Yet another object of the present invention is to provide a rear brake light system that can calculate the distance and the closing velocity of a trailing vehicle to determine whether the vehicle is too close to the lead vehicle or if the trailing vehicle is closing at a rate of speed above a maximum threshold.

Another object of the present invention is to provide a rear brake light system that contemplates either a built-in or attachable transmitter and receiver, whereby both are located along the rear of the lead vehicle and direct signals rearward therefrom.

Another object of the present invention is to provide a rear brake light system that can be integrated into existing vehicles or be incorporated into new vehicles.

Another object of the present invention is to provide a rear brake light system that provides a visual or audible alert to the lead vehicle motorist within the vehicle cabin in the event an impending rear-end collision is detected.

A final object of the present invention is to provide a rear brake light system that comprises components that may be readily fabricated and assembled to permit relative economy, commensurate with durability and reliability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows an illustrative overhead view of the system in operation, whereby the lead vehicle is transmitting signals that are reflected off of a trailing vehicle to provide distance signals.

FIG. 1B shows another illustrative view of the system in operation, whereby the system has determined scenario beyond acceptable limits, and has initiated pulsing of the rear brake lights after application of the lead vehicle brakes.

FIG. 2 shows a diagram of the calculated closing velocity of the trailing vehicle relative to a pre-determined maximum closing velocity.

FIG. 3 shows a diagram of the calculated distance between the lead vehicle and the trailing vehicle compared to a pre-determined maximum closing velocity.

FIG. 4 show a high level system view of the system and its inputs and outputs.

FIG. 5 shows an embodiment of the system circuit diagram for calculating the trailing vehicle range and closing speed, and for pulsing the rear brake lights.

FIG. 6 shows an embodiment of the system deployed within a license plate frame, whereby the transmitter and receiver are directed rearward and the system components are supported within a housing along the frame.

### DETAILED DESCRIPTION OF THE INVENTION

Reference is made herein to the attached drawings. Like reference numerals are used throughout the drawings to depict like or similar elements of the rear brake light system of the present invention. For the purposes of presenting a brief and clear description of the present invention, the preferred embodiment will be discussed as used for calculating the range and closing speed of a trailing vehicle, and activating or pulsing the brake lights of the lead vehicle in order to alert the trailing motorist. The figures are intended for representative purposes only and should not be considered to be limiting in any respect.

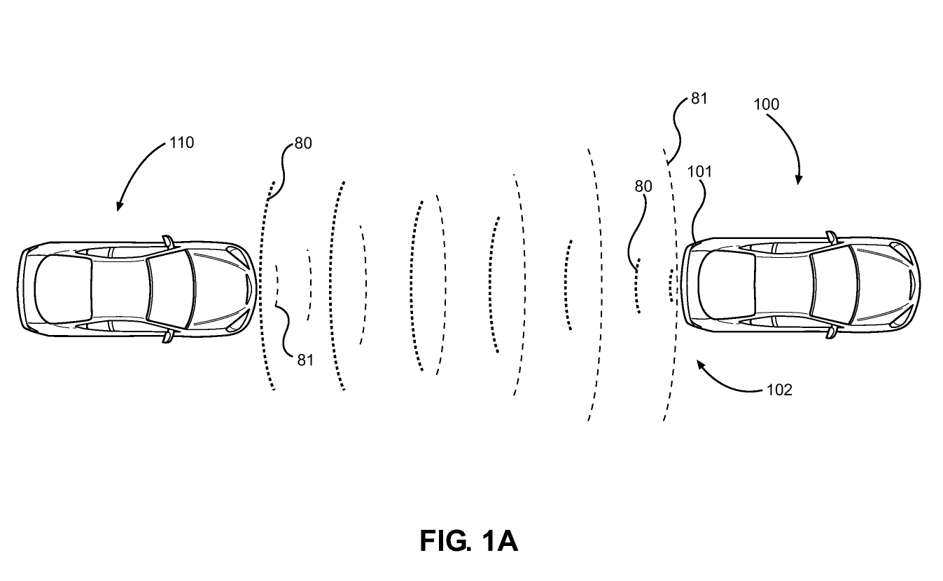

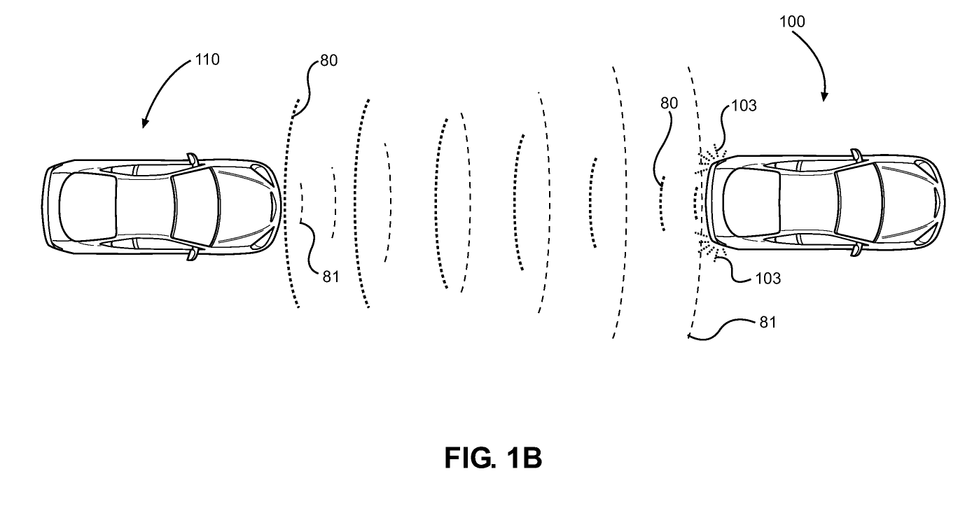

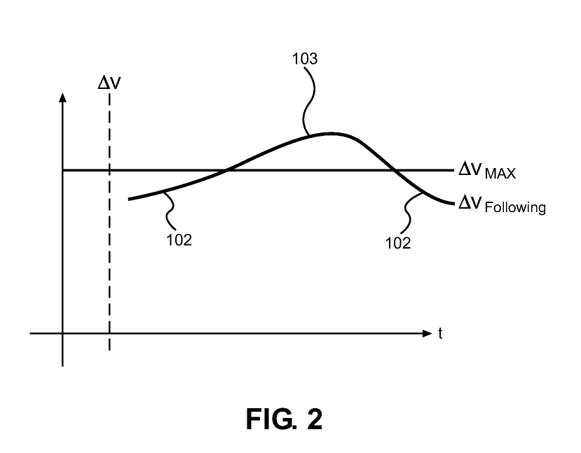

Referring now to FIGS. 1 and 2, there are shown illustrative views of the system in operation. While in operation, the lead vehicle 100 is actively monitoring the distance between the trailing vehicle 100 and a trailing vehicle 110. This distance is defined as the range between vehicles. The system is deployed on a lead vehicle 100 and directs sensor signals rearward to monitor the location of the trailing vehicle 110 relative thereto. To prevent a rear-end collision, at highway speeds or at low speeds, the system operably activates and/or pulses 103 the rear brake lights 101 of the lead vehicle 100 if a given condition is registered. The system uses the distance and change in distance between the two vehicles (i.e. the closing speed) to determine if an unsafe event is present. The system includes a preprogrammed threshold for acceptable closing speeds and ranges, which may be uniform across all vehicle speeds or a calculated threshold that is dependent upon the lead vehicle speed.

Installed on the lead vehicle 100 is a transmitter and receiver, which are disposed along the rear of the vehicle. The transmitter directs a signal 80 rearward, which is then reflected from the trailing vehicle 110 and back towards the lead vehicle 100. The return signal 81 is received by the receiver of the lead vehicle 100. The time delay between transmission and receipt of the signal is used to calculate range. Taken over increments of time at a high frequency of transmission, the range over time can be monitored, which is the closing speed of the trailing vehicle. The system may calculate the derivative of the range to obtain instantaneous closing speed, or individual data points may be compared to obtain the speed via the slope between distance data points over time. The type of transmitter/receiver deployed will dictate the exact calculation programmed into one or more microprocessors onboard the lead vehicle 100.

Referring now to FIG. 2, there is shown a representative diagram that illustrates the calculated closing velocity 102 of the trailing vehicle relative to the lead vehicle, comparing the values derived against a preprogrammed maximum. The system uses the transmitter/receiver signals generate range measurements, which are then used to calculate the closing velocity of the trailing vehicle. Closing velocity is used to determine if the trailing vehicle is closing at an excessive rate that would reduce its ability to timely apply its brakes and slow or stop prior to a rear-end collision. This is particularly critical at higher speeds, but is similarly important in low speed traffic where fender benders are common.

The system continually calculates the closing speed and compares it to a preset maximum. The preset maximum may be uniform across all vehicle ranges, or alternatively the maximum closing speed may be calculated based on the range between the vehicles. A variable maximum provides for different allowable closing speeds at different ranges, whereby greater closing speeds may be allowed for more distant vehicles as there is more opportunity for the trailing vehicle to recognize the braking event ahead and apply the brakes in time to effectively slow or stop their vehicle before a collision.

FIG. 2 shows a graph of closing speed over time, whereby the maximum closing speed (ΔVmax) may be defined as a variable number determined based on range between the vehicles, or may be the single value across all vehicle ranges. As shown, the closing velocity of the trailing vehicle (ΔVfollowing) is measured over time (t). The closing velocity is compared to the maximum closing velocity value (either variable or uniform across vehicle range) to determine whether the closing velocity is below 102 the maximum or above 103 the maximum threshold. When the closing velocity is above 103 the maximum threshold, the system recognizes a dangerous situation whereby the closing speed of the trailing vehicle is out of acceptable limits. Upon detection of this event, the system pulses the brake lights at a high rate to improve communication and alert the trailing vehicle of a possible severe braking event. This can be activated in conjunction or independently of application of the brake pedal by the lead vehicle motorist, depending upon design of the system.

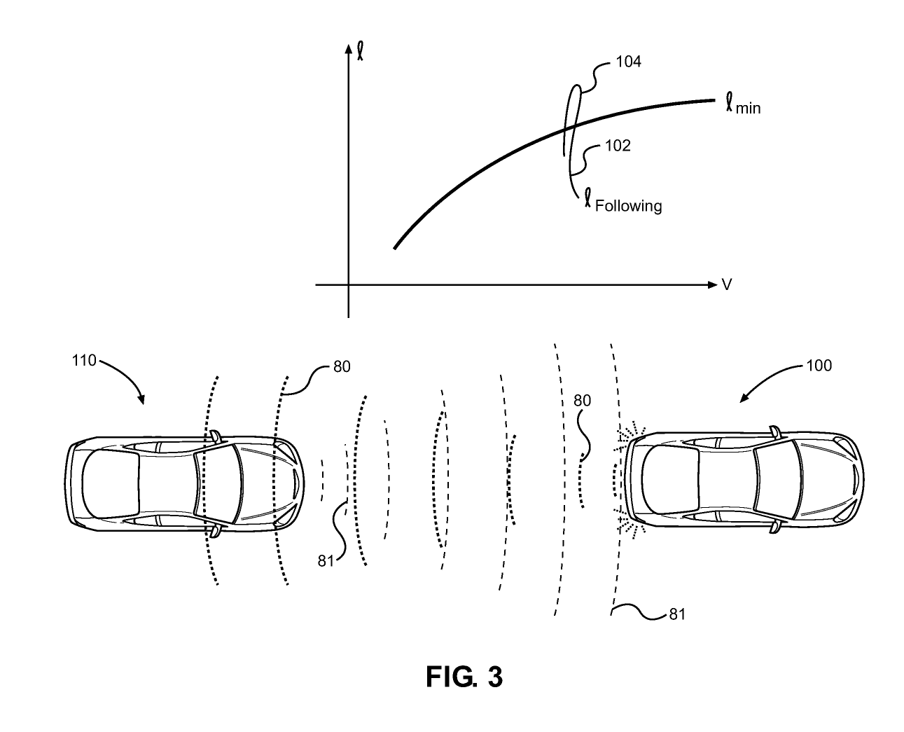

Referring to FIG. 3, there is shown a graph illustrating the measured distance between the lead vehicle 100 and the trailing vehicle 110. Signals 80 from the transmitter are projected rearward, and the return signal 81 is reflected back towards the lead vehicle and received by the receiver. The range between the two vehicles (lfollowing) is tracked over time. Based on the lead vehicle's speed, the range is compared to a minimum allowable range (lmax). The minimum allowable range is preferably a variable that changes with the speed (V) of the lead vehicle 100, whereby shorter minimum ranges are provided at lower speeds, and vice versa. If the range is below 102 the minimum for a given speed, the system will illuminate the rear brake lights of the lead vehicle to warn the trailing vehicle, and to signal to the trailing motorist that he or she may be traveling too close to the lead vehicle. When the range is above 104 the minimum, the lights operate normally and without interaction from the present system.

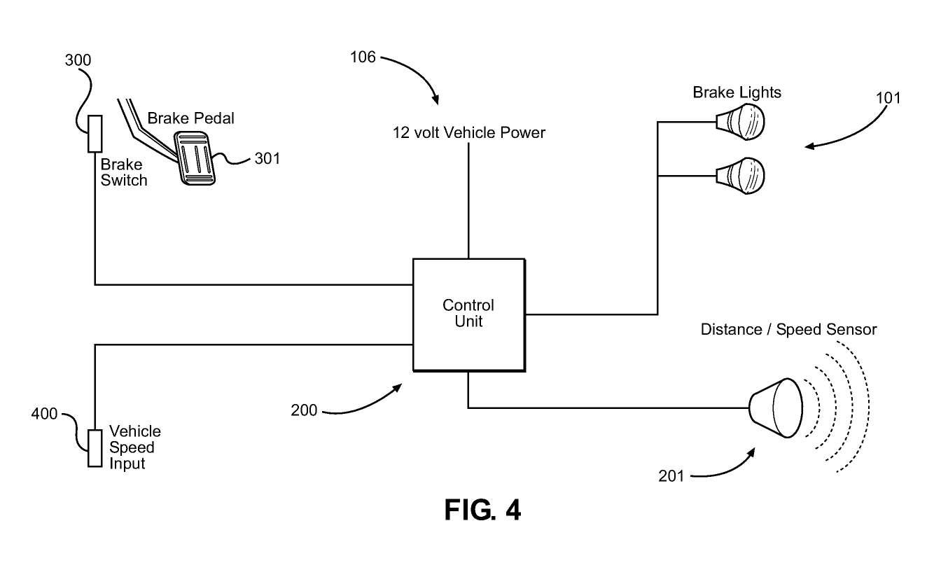

Referring now to FIG. 4, there is shown a high level system diagram of the present invention. The system comprises a control unit 200 having one or more microprocessors that can calculate the trailing vehicle closing speed based on distance inputs, and furthermore receive inputs and provide necessary outputs to the brake lights. The control unit 200 is powered by the vehicle's electrical system, whereby power 106 directly from the vehicle battery or the electrical system run by the alternator is provided. The inputs to the control unit 200 include a vehicle brake switch 300, and sensor inputs from the transmitter/receiver 201 and optionally the vehicle speed input 400.

In one embodiment of the system, the brake lights only pulse when the vehicle brake pedal 301 is depressed, and if the control unit 200 determines a trailing vehicle is closing too fast. The control unit 200 pulses the brake lights 101 of the lead vehicle. Another embodiment does not rely on brake inputs 300 from the user to energize and pulse the rear brake lights, and operates independently of input from the user. This embodiment is preferred and pulses the brake lights 101 if the distance inputs 201 over time are calculated by the control unit 200 and determined to realize a vehicle approaching at too great of a speed relative to the lead vehicle.

The signal from the transmitter and receiver 201 provides input regarding the position of the trailing vehicle relative to the rear bumper of the lead vehicle, while the brake switch 300 and optional speed input 400 provide inputs from the lead vehicle. The speed input 400 exists in one embodiment of the system, and comprises a connection to the vehicle speed sensor to determine the lead vehicle speed. Optionally, this input 400 can be provided by a Global Positioning System (GPS) module that can determine the lead vehicle speed. The speed input can be used to calculate the minimum allowable following distance, whereby the brake lights are activated if a trailing vehicle is following too close at a given speed.

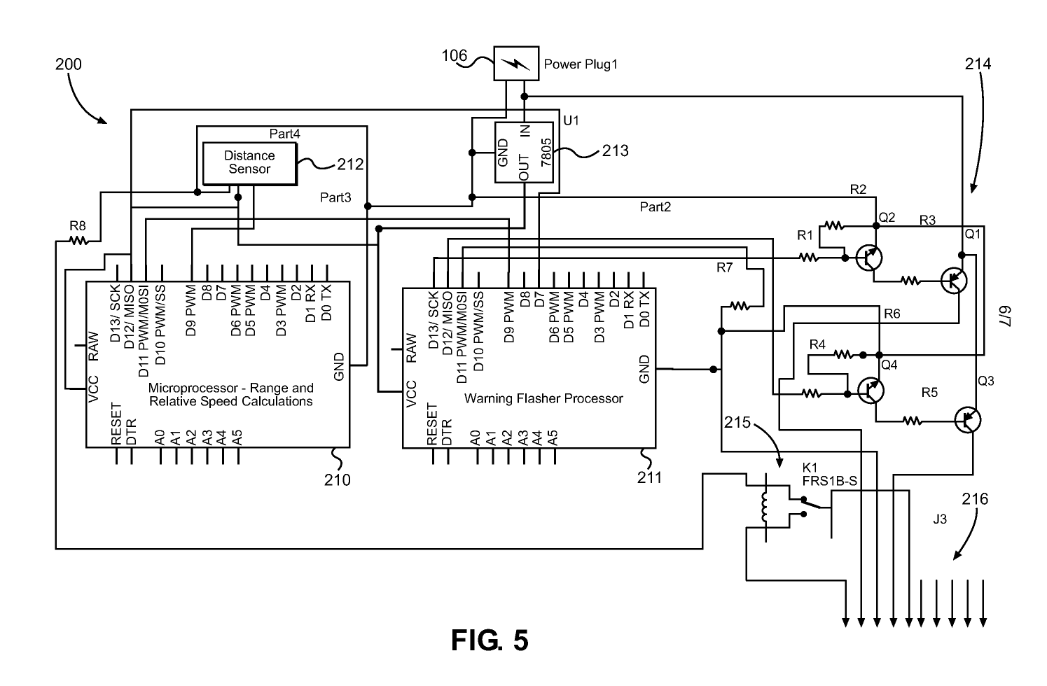

Referring now to FIG. 5, there is shown an embodiment of the control unit 200 of the present invention. The control unit 200 comprises a circuit having least two microprocessors, a first microprocessor 210 for performing minimum range and relative speed calculations, and a second microprocessor 211 for controlling the brake lights 211. Inputs are received by the first microprocessor 210 by way of the distance sensors 212 disposed along the rear of the vehicle. The distance sensors 212 comprise a transmitter and receiver that can determine the distance between a trailing vehicle and the lead vehicle bumper. The distance sensor 212 may comprise one or more ultrasonic sensor, LIDAR, radar sensor, IR sensor, laser sensor or the like. It is not desired to limit the exact transmitter/receiver sensor to one specific technology, but rather it is desired to describe a sensor that is capable of determine the distance between a trailing vehicle and the sensor that updates at a high frequency and has a sufficient range and field of view in order to carry out the task of tracking the distance to the trailing vehicle.

Along with the first 210 and second 211 microprocessors, there are a plurality of resistors, transistors 214, and voltage converts 213, which would be used to convert the low level signals of the microprocessor 211 to twelve volt output to drive the brake lights and the warning lights 216. A relay may also be used 215 in the circuit to energize the lights 216. In some embodiments of the system, a GPS module may be included in as an input, whereby the first microprocessor 210 or a third microprocessor can use speed data to determine whether the trailing vehicle is following too close at a given speed.

In addition, an interior warning alert is contemplated within the lead vehicle. This warning alert comprises one of an audible and/or visual alert that warns the lead vehicle motorist of an impending rear-end collision. When the system detects a vehicle approaching above a threshold closing velocity, or when a trailing vehicle is following too close to the lead vehicle, the interior warning alert is activated. The alert comprises an audible signal and/or visual indicator, whereby the user is alerted and can take necessary evasive maneuvers if possible to avoid a collision.

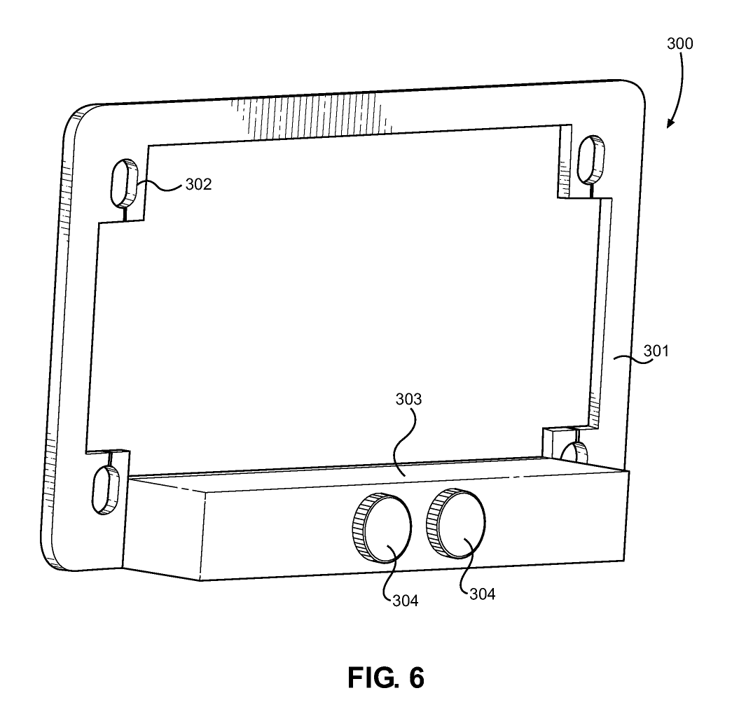

Referring now to FIG. 6, there is shown a view of one embodiment of the structure supporting the rear-mounted sensors along the lead vehicle. In this embodiment, a license plate frame 300 is provided that includes a frame 301 and a housing 303. The housing supports the distance sensors, whereby a transmitter and receiver 304 are supported therein. The transmitter sends a signal outward from the housing 303, which returns after being reflected from a trailing vehicle. The return signal is received by the receiver and the time difference between sent/received signals is used to calculate distance data, which is an input into the control circuit.

Overall, the present invention provides an emergency warning system for a vehicle and an improved communication system. The system may either be installed into a car or can be retrofitted onto an already existing brake system. The system includes of a rear-mounted sensor that determines the distance of a following vehicle. The sensor provides input to the control circuit, which calculates the relative speed of the trailing vehicle. If the following car is travelling at an excessive rate of speed relative to the speed of the lead vehicle, the system energizes the brake lights to rapidly pulse. This serves as a signal to catch the attention of the following driver that the car ahead of him has either applied the brakes or is rapidly approaching, and therefore brake application is necessary to prevent a rear-end collision. Optionally, the system provides this feedback only when the brakes are applied in the lead vehicle. Still further, the brake lights can be statically illuminated if the trailing vehicle is trailing too close to the lead vehicle for a given speed. This could also be used separate the two vehicles in traffic and prevent tailgating. Overall, the system can be deployed in several different configurations to serve as an improved communication tool for motorists.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. The supporting vehicle may be an automobile, a truck, or even a motorcycle.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A vehicle brake light system, comprising:
a control unit comprising at least one microprocessor;
at least one transmitter and receiver configured to be mounted to the rear of a lead vehicle;
said transmitter and receiver configured to project signals rearward of said vehicle and determine a distance between said vehicle and a trailing vehicle;
said control unit receiving electrical power from said lead vehicle and in electrical connection with one or more rear brake lights of said lead vehicle;
said at least one microprocessor calculating closing speed of said trailing vehicle relative to said lead vehicle;
said at least one microprocessor configured to pulse said one or more rear brake lights if said closing speed is above a defined threshold value.

2. The vehicle brake light system of claim 1, wherein:
said control unit is further in connection with a brake pedal sensor on said lead vehicle, and said at least one microprocessor is configured to pulse said one or more rear brake lights only when said brake pedal sensor registers brake application of said lead vehicle.

3. The vehicle brake light system of claim 1, wherein:
said control unit is further in connection with a vehicle speed sensor on said lead vehicle, and said at least one microprocessor is configured calculate said distance of said trailing vehicle and compare said distance to a speed received from said vehicle speed sensor;
said at least one microprocessor being configured to illuminate said one or more rear brake lights when said distance is below a minimum threshold at said speed.

4. The vehicle brake light system of claim 1, wherein:
said control unit is further in connection with a GPS module on said lead vehicle, and said at least one microprocessor is configured calculate said distance of said trailing vehicle and compare said distance to a speed received from said GPS module;
said at least one microprocessor being configured to illuminate said one or more rear brake lights when said distance is below a minimum threshold at said speed.

5. The vehicle brake light system of claim 4, further comprising:
an interior warning alert that activates when said distance is below a minimum threshold at said speed.

6. The vehicle brake light system of claim 1, further comprising:
an interior warning alert that activates when said closing speed is above a defined threshold value.

7. A method of activating the brake lights of a vehicle to warn trailing motorists, comprising the steps of:
employing on a lead vehicle a control circuit having at least one microprocessor to receive input from at least one transmitter and receiver;
determining distance between said lead vehicle and a trailing vehicle using said from at least one transmitter and receiver;
calculating a closing speed of said trailing vehicle relative to said lead vehicle using said control circuit;
determining whether said closing speed is above a maximum acceptable closing speed;
pulsing at least one rear brake light if said closing speed is above said maximum acceptable closing speed.

8. The method of claim 7, further comprising:
determining a speed of said lead vehicle;
calculating said maximum acceptable closing speed based on said speed of said lead vehicle using said control circuit.

9. The method of claim 7, further comprising:
determining a speed of said lead vehicle;
calculating a minimum acceptable trailing distance based on said speed of said lead vehicle using said control circuit;
illuminating said at least one rear brake light if said distance of said trailing vehicle is below said minimum acceptable trailing distance.

10. The method of claim 9, further comprising:
activating an interior warning alert when said distance of said trailing vehicle is below said minimum acceptable trailing distance.

11. The method of claim 7, further comprising:
activating an interior warning alert when said closing speed is above said maximum acceptable closing speed.
